(19) United States
(12) Patent Application Publication
(10) Pub. No.: US 2011/0282847 A1
(43) Pub. Date: Nov. 17, 2011

(54) Methods and Systems for Validating Queries in a Multi-Tenant Database Environment

(75) Inventors: Jesse Collins, San Francisco, CA (US); Matthew Peterson, San Marcos, CA (US); John F. O'Brien, San Francisco, CA (US)

(73) Assignee: salesforce.com, inc., San Francisco, CA (US)

(21) Appl. No.: 12/897,228

(22) Filed: Oct. 4, 2010

Related U.S. Application Data
(60) Provisional application No. 61/334,305, filed on May 13, 2010.

(51) Int. Cl. G06F 17/30

(52) U.S. Cl. 707/688; 707/E17.007

(57) ABSTRACT

In accordance with embodiments, there are provided mechanisms and methods for validating queries. These mechanisms and methods for validating queries can enable embodiments to provide more reliable and faster execution of queries both in development and in production. In an embodiment and by way of example, a method for validating queries is provided. The method embodiment includes capturing a query that is directed to a multi-tenant database. A plan is determined by which the query will be applied to the database. The plan is statically analyzed for performance. Then a performance measure is applied to the query.

### CLAIM OF PRIORITY

This application claims the benefit of U.S. Provisional Patent Application 61/334,305 entitled Methods and Systems for Validating Queries in a Multi-Tenant Database Environment, by Collins et al., filed May 13, 2010 (Attorney Docket No. 008956P018Z), the entire contents of which are incorporated herein by reference.

### CROSS REFERENCE TO RELATED APPLICATIONS

The following commonly owned, co-pending United States patents and patent applications, including the present application, are related to each other. Each of the other patents/applications are incorporated by reference herein in its entirety:

U.S. patent application Ser. No. 12/262,744 entitled PREVENTING MISUSE OF DATABASE SEARCHES, by Hofhansl et al., filed Oct. 31, 2008; and

U.S. Pat. No. 7,529,728 entitled QUERY OPTIMIZATION IN A MULTI-TENANT DATABASE SYSTEM, by Weissman et al., issued May 5, 2009.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to validating queries from users or developers in a database network system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. The reliable and efficient operation of queries on the database system to deliver information to a user has been and continues to be a goal of administrators of database systems.

Unfortunately, conventional database approaches might process a query relatively slowly if, for example, the query is inartfully drafted or the data is not well adapted to handling queries of a particular kind. A database system may also process a query relatively slowly if, for example, a relatively large number of users substantially concurrently access the database system.

### BRIEF SUMMARY

In accordance with embodiments, there are provided mechanisms and methods for validating queries. These mechanisms and methods for validating queries can enable embodiments to provide more reliable and faster execution of queries both in development and in production.

In an embodiment and by way of example, a method for validating queries is provided. The method embodiment includes capturing a query that is directed to a multi-tenant database. A plan is determined by which the query will be applied to the database. The plan is statically analyzed for performance. Then a performance measure is applied to the query.

While the present invention is described with reference to an embodiment in which techniques for validating queries are implemented in a system having an application server providing a front end for an on-demand database service capable of supporting multiple tenants, the present invention is not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 is operational flow diagram illustrating a high level overview of a technique for validating queries in an embodiment;

FIG. 2 is operational flow diagram illustrating a high level overview of a more detailed technique for validating queries in an embodiment;

FIG. 3 is an operational flow diagram illustrating a high level overview of a technique for performing a database search in an embodiment;

FIG. 4 is a diagram of an example data model for sharing in an embodiment;

FIG. 5 illustrates a block diagram of an example of an environment wherein an on-demand database service might be used; and

FIG. 6 illustrates a block diagram of an embodiment of elements of FIG. 5 and various possible interconnections between these elements.

### DETAILED DESCRIPTION

### General Overview

Systems and methods are provided for validating queries. These systems and methods are particularly valuable in the context of a multi-tenant database.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for validating queries will be described with reference to example embodiments.

### Validation

Poor query plans can cause severe performance issues in production when they run on large data sets. Unfortunately, these performance problems can be hard to detect in a test environment that uses small data sets or data sets with a limited variety of data. While a small data set allows a test to run quickly, some problems will not be detected with a quick or simplified run. In some embodiments, the present invention allows some classes of common query plan problems to be detected. The query plan validation can be run quickly and frequently without a large test data set.

According to embodiments of the invention, a tool can be used to generate queries that are designed specifically to exercise different indexes, explain the queries, and check to ensure that the queries choose a correct index of a database. Another tool can be used to examine the effects of changes to stored database statistics over time. Statistical changes can then be tested by queries to check for unintended consequences. Another tool can be used as a sweep tool to identify tables and indexes in a database that has poor statistics.

In a multitenant database system, there can be an extremely large variety of different potential queries. Some of the queries may cause negative impacts on the system or provide poor performance for tenant users. A flexible schema and powerful APIs (Application Programming Interface) can create further uncertainty by allowing different users to generate many new and different queries that have never before run on the database system.

To validate the performance of a query, the query is first captured in some way. In the present description, the queries are directed to a multi-tenant database. However, the approaches described herein can also be applied to other types of databases. A query plan validator can be hooked into a complete test and validation system or into a database management system in several different places. Any one or more of these places or other places can be used to identify query plan problems.

The validator can capture and inspect dynamic SQL (Structured Query Language) or other types of queries that are produced for the validator. These can be used, for example, by automated test runs to find regressions. Alternatively, the queries can be produced for system test or load test runs. In some applications, many queries are generated in order to exercise tables of the database. One or more of these generated test queries can be captured for analysis. Queries can be selected for the validator based on run-time, reliability, or any other desired factor. Both dynamic and static queries can be analyzed.

The validator can also capture static queries parsed from other more complex applications and languages, for example PL/SQL (Procedural Language/Structured Query Language, an extension of SQL by Oracle) files and other types of production files. The queries can include queries generated by users or tenants of the database while using the database system. These queries can be intercepted by the system as they are submitted, or captured after they have been executed in order to avoid interfering with the customer's use of the system.

In one example, queries submitted in production, that is queries submitted by users are monitored. If a particular query runs slowly, or has slow performance, then it is flagged for later analysis. This analysis can include applying the validator disclosed herein. Such an analysis after a query has already been applied allows a database system to be improved in a separate process without interfering with the use of the database. The improvements may include analyzing metadata and query formulation. Queries can be identified using a timer, using a time out log, or using a progress log. As an alternative, the validator can parse SQL queries out from AWR (Automatic Workload Repository) reports or other reports compiled by the database system and evaluate the parsed queries for query plan defects.

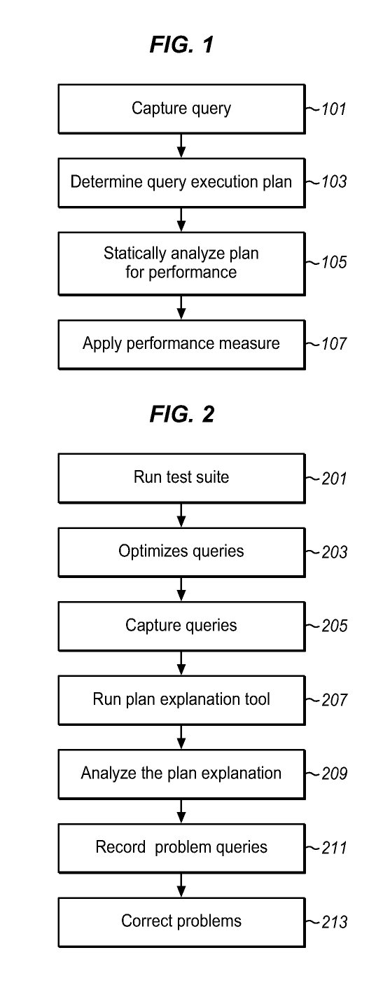

The process of capturing a query is represented in FIG. 1 by block 101. FIG. 1 is a simplified flow chart diagram for validating a query according to an embodiment of the invention.

Having captured a query, it can be analyzed. A variety of different analytical measures can be applied, depending on the application. In one embodiment, the query is analyzed to determine how it is likely to be applied to the database. This is represented by block 103 of FIG. 1. Some database systems offer a plan explanation tool, such as an Oracle Explain Plan tool. Such tools perform a static analysis of the query and then provide a plan for how the system is likely to execute the query. The plan will typically explain which tables are accessed, how they are accessed, which operations will be performed on each table and on the results, and in which order.

This plan can then be analyzed to determine how the query would perform on the database system according to the plan. This is represented by item 105 in FIG. 1. This can be a static analysis or it can be a dynamic analysis performed on the database or a test database. The analysis can be automated to check the plan for a wide range of different factors. In one embodiment, the validator evaluates the returned plans, by looking for a set of patterns known to cause performance issues.

The patterns can include full table scans. Scanning all of a large table can cause a query to run slowly. The patterns can include merge join cartesian operations, which might use substantial processing resources. Nested loop joins that do not use an index containing the join key can run very slowly through large tables. Table accesses on queries that are designed to be index-only run much slower than an index access and can interfere with other operations.

Any one or more of these issues can be searched for in a plan. Additional operations and issues can also be identified. These might include queries with a hash semijoin or an anti join hint where the plan does not contain the operation corresponding to the anti-join.

Having identified any one or more of these or other patterns, some measure can be taken to improve the use of the database system for users. This is represented by block 107 of FIG. 1. The measure may be applied to the query or to the database system. If the query is generated by some other utility, including a user query interface, then the measure can be applied to the query interface.

A simple measure to avoid the system impact of a slow or poor performance query is to block it from being used. In other words, when the query is submitted by any user, then its submission is detected and it is prevented from being executed on the database. Such a measure can be extended to include queries that resemble the low performance query.

Alternatively, the query can be modified to change its execution against the database. In some cases, the results of the query will be unchanged, but the method for obtaining the results is changed. In one example, a query that scans a full table can be rewritten to scan a corresponding index. In another example, a query can be rewritten to access the tables or indexes in a different order, narrowing the search for each table. A query can also be translated into another language for better execution. Some languages are better suited for some databases, while other languages are better suited to other databases. In other cases, the results of the query or the presentation of its results will be changed by the measure that improves its performance.

Alternatively, the database can be modified to better accommodate the query. Such a modification might include adding index tables, adding data tables, adding keys to direct a query to an appropriate place in another table, or restructuring existing tables. The particular measure can be selected in part based on the ease of making the change and also based on how frequently similar queries are expected to be received.

FIG. 2 shows another embodiment of the invention having additional detail not shown in FIG. 1. While more operations are shown in FIG. 2, not all of these operations are necessary and additional operations may be added, if desired. At block 201 of FIG. 1, an automated test suite runs a variety of different operations including running a varied set of logical queries. The automated test suite can perform many different functions to exercise the databases and to check user interfaces and applications. As an alternative, as mentioned above, there can be other sources of queries, such as user input, outside applications, maintenance systems, etc.

At block 203, a query optimizer or query generator optimizes the queries of the automated test suite and converts the queries into SQL queries ready for the database. As mentioned above, these queries can come from many different sources or all from an automated test suite. In the examples above, the queries are converted into SQL queries because, in the described embodiment, the databases are configured to run with SQL queries. However the particular structure and language of the database can be adapted to suit any type of database. The query optimizer is a system that is designed to eliminate errors and redundancies in the query so that it can run without errors on the database. One example of a query optimizer is described in U.S. Pat. No. 7,529,728 to Weissman et al., the contents of which are incorporated herein by reference. However, other query optimization techniques may be used instead.

At block 205, the query plan validator captures one or more of the optimized SQL queries. As mentioned above, the queries, can be captured before or after execution. A variety of different criteria can be used to determine which queries to capture, or all of the queries can be captured. In an automated test suite application, all of the queries can be captured before execution without interfering with use of the underlying database.

At block 207, the query plan validator runs on Oracle Explain Plan, or a similar tool depending on the nature of the database and retrieves the result. The execution plan explanation will describe the execution of the query so that any performance issues can be discovered. The plan explanation is retrieved from the tool and then made available for inspection.

At block 209, the execution plan explanation is inspected. As described above, static analysis can be used to look for patterns that are likely to cause poor performance on the anticipated data sets.

The query plan validator can be summarized as capturing SQL queries, running explain plans, analyzing the plans, and then taking a measure to improve performance. An automated test suite can be used to run a variety of different operations. The operations can involve running a varied set of logical queries.

For each query, a query optimizer and generator optimizes queries and converts them into SQL queries ready for the database. The query plan validator captures the SQL query before, after, or in place of it being executed. The query plan validator then runs an Oracle Explain Plan or similar tool, retrieves the result, and inspects the plan via static analysis to look for a variety of patterns that are likely to cause poor performance on large data sets. Several different patterns that can cause poor performance are mentioned above. Any of these or other patterns may be used by the static analysis.

While the static analysis is looking for queries for poor performance, in the described examples, the static analysis does not measure actual performance. Performance is estimated based on the detected patterns. Accordingly, the patterns used by the static analysis can be adapted to suit a particular data set and database. The best patterns to look for may vary depending on both the database and the data set. Experience with any particular database or data set may result in some patterns being discovered as negatively affecting performance and other patters which were thought to affect performance being found to not have a significant impact. As a result the particular patters for any static analysis may vary over time.

The accuracy of the analysis can be improved by actually measuring the performance of queries and then comparing that to the detected patters. As mentioned above, queries can be captured after execution. In this way the performance of a query can be measured and logged for later reference when validating their performance. Similarly, after corrective measures have been taken, the query can be run again. The second execution can also be measured and compared to the first run to determine whether the query's performance has been improved and whether additional measures should be taken.

At block 211, the query plan validator records any queries with problems. The record can be provided as an output to developers to all the developers to inspect and correct the problems. At block 213, the problems can be corrected or mitigated in many different ways. These include hint changes, database statistic changes, and SQL changes to the queries, among others. Additionally, as suggested in the context of FIG. 1, other measures may be taken to reduce the impact of the query, such as blocking it or scheduling it to run at a time that will be less disruptive to other users.

### Query Overview

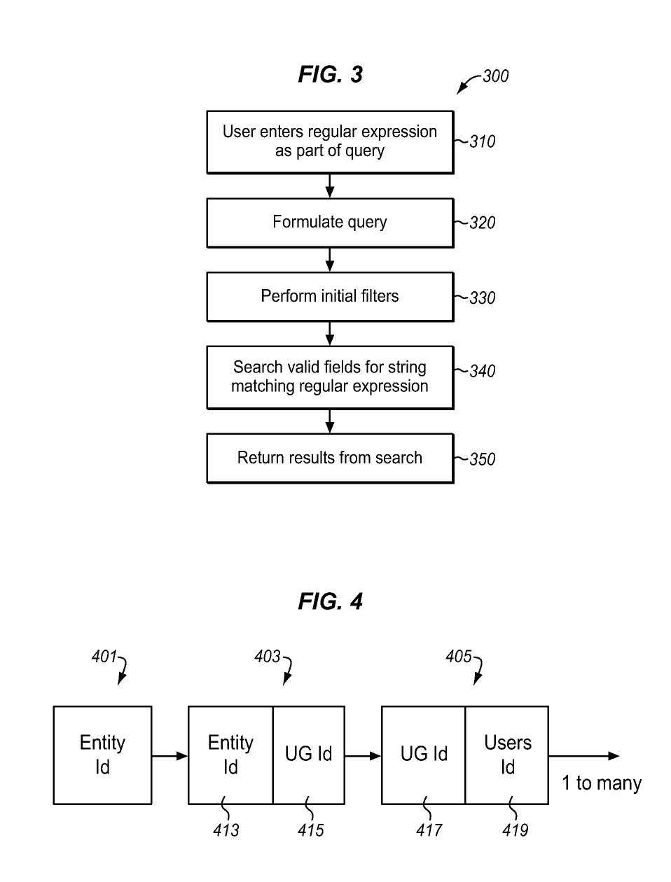

By way of background, FIG. 3 is a flowchart illustrating a method 300 for performing a database search according to an embodiment of the present invention. A user may enter a regular expression in order to find particular fields of a database. Additional parameters for the search may request particular data associated (e.g. linked) with that field. For example, when a field is a column and/or row, the additional parameters may select particular data from that column.

At block 310, the user enters a regular expression. In one embodiment, this may be done by entering symbols and characters into a window of an application (e.g. application running on the database). In another embodiment, characters may be combined with actions (e.g. corresponding to particular symbols) chosen from lists (such as drop down lists).

At block 320, a query is formulated based on the regular expression that was entered. For example, an application server of a database system may formulate the query. The query may include other filters (e.g. additional parameters) entered by the user or imposed by the database system. For example, the system may allow access to only data to which the user is authorized.

At block 330, some filters may be imposed in order to limit the number of character strings searched. The application can apply the filters input by the user or imposed by the database system prior to using the regular expression. For example, the number of fields to be searched can be decreased by applying the filters.

At block 340, valid fields (i.e. fields passing the initial filters) are searched for a string matching the regular expression. Various mechanisms may be used to perform the search.

At block 350, the results are returned. In one embodiment, the matching strings may be aggregated and then returned all at once. In another embodiment, results associated with each matching string may be returned when that matching string is found. Additional filtering or searches may be performed using the matching strings. For example, data linked to a particular string may then be searched using filters (e.g. parameters) input by a user.

As an example of the operation of queries, one tenant of a multi-tenant database might be a company that employs a sales force where each salesperson uses the database system to manage their sales process. Thus, a user might maintain contact data, leads data, customer follow-up data, performance data, goals and progress data, etc., all applicable to that user's personal sales process. While each user's data might be separate from other users' data regardless of the employers of each user, some data might be organization-wide data shared or accessible by a plurality of users or all of the users for a given organization or tenant. Thus, there may be some data structures that are allocated at the tenant level while other data structures are managed at the user level.

User systems, developer systems and operations and management systems communicate with application servers to request and update system-level and tenant-level data from the multi-tenant database system. Typically this involves sending one or more queries to the database system. An application server or the user system can generate a specified query form such as one or more SQL statements that are designed to access the desired information. The database system then generates query plans to access the requested data from the database.

The query plan, as mentioned above, indicates how the query will be executed on the database. The query plan may include, for example, a search for a particular set of characters, i.e. a character string in a particular row or column of a database table (object). A table generally contains one or more data categories logically arranged as columns or fields in a viewable schema. Each row or record of a table contains an instance of data for each category defined by the fields. For example, a CRM (Customer Relationship Management) database may include a table that describes a customer with fields for basic contact information such as name, address, phone number, fax number, etc. Another table might describe a purchase order, including fields for information such as customer, product, sale price, date, etc.

As examples of different query plans, consider a query plan for a “boss” vs a “lower level employee.” Differences in access and privilege levels can cause the same query to use a different plan. Consider a query of the form: “Show me all accounts that I can see” in a private account sharing model. An example of a data model for sharing appears in FIG. 4. In FIG. 4, a middle table 403 is a sharing table. It allows entity Id data from the first table 401 to be shared through the middle table to particular users. The middle table takes an entity Id 413 and generates a user/group Id 415. A final table 405 is a user/group “blowout”. The final table describes which users are contained in a group, or are above a user in the role hierarchy (UG=User or Group)). Accordingly, the user/group Id 417 is blown out into individual user Ids 419. According to one aspect, for a “lower level employee” user, it is typically most advantageous to join these tables starting from the right, filtering on user Ids to form a temporary result of the rows that can be seen. Because the user can not see many rows, this will yield a relatively selective path. An example query is shown as Table 1.

TABLE 1

```
select a.name “ACCOUNT.NAME”,
from sales.account a,
    (select distinct s.account_id
    from core.ug_blowout b, sales.acc_share s
        where s.organization_id = ?
        and b.organization_id = ?
        and b.users_id = ?
        and s.ug_id = b.ug_id
        and s.acc_access_level > 0) t,
    core.users u
where (t.account_id = a.account_id)
and (u.users_id = a.owner)
and (a.deleted = ‘0‘)
and (a.organization_id = ?)
and (u.organization_id = ?) )
```

Conversely for a “boss” user who can see most of the entity records in the organization, it is typically most advantageous to begin the query from the left and use a nested loop query plan onto the sharing table (acc_share), an example of which is provided in Table 2.

TABLE 2

```
select a.name “ACCOUNT.NAME”,
from sales.account a,
core.users u
where (u.users_id = a.owner)
and (a.deleted = ‘0‘)
and (a.organization_id = ?)
and (exists (select 1 from core.ug_blowout b,
    sales.acc_share s
    where s.organization_id = ?
    and b.organization_id = ?
    and b.users_id = ?
    and s.ug_id = b.ug_id
    and s.acc_access_level > 0
    and s.account_id = a.account_id) )
and (u.organization_id = ?)
```

Note that the query of Table 2 in general runs in relatively constant (reasonable) time for all users in an organization. It may not be particularly fast since it must look at all top-level entity records, but it is suitable for a boss who can in fact see most records. The first “lower level employee” query runs much faster for users who in fact can not see many records, but it may run much slower for bosses who can see all records. Accordingly, the query plan can have a significant impact on the speed of a query and its efficiency.

### System Overview

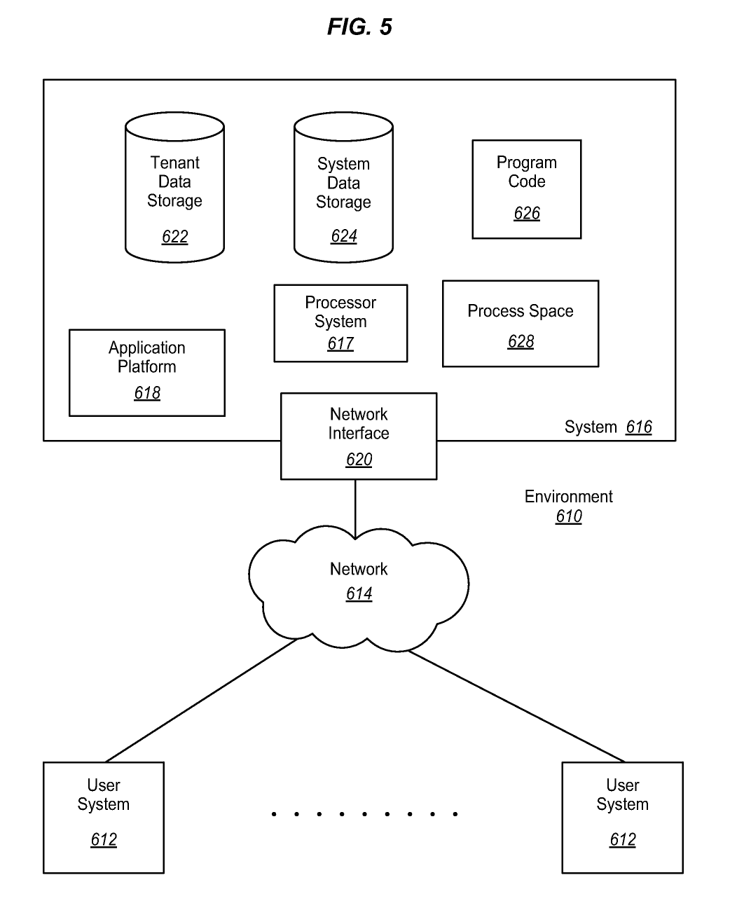

FIG. 5 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

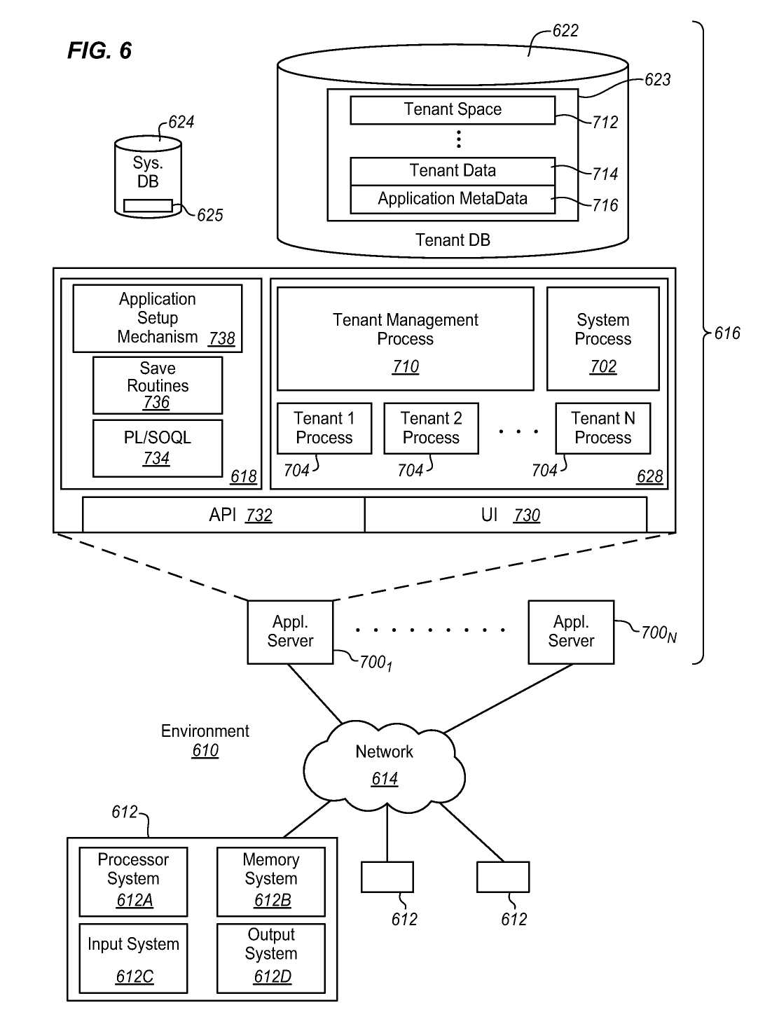

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in FIG. 5 (and in more detail in FIG. 6) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 18 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 5, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 16 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 5, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 5 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 6 also illustrates environment 610. However, in FIG. 6 elements of system 616 and various interconnections in an embodiment are further illustrated. FIG. 6 shows that user system 612 may include processor system 612A, memory system 612B, input system 612C, and output system 612D. FIG. 6 shows network 614 and system 616. FIG. 6 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 5. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 6, system 616 may include a network interface 620 (of FIG. 5) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 34 that provides a programming language style interface extension to API 732. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT DATABASE ON-DEMAND DATABASE SERVICE issued Jun. 1, 2010 to Craig Weissman, which is incorporated in its entirety herein for all purposes. Invocations to applications may be detected by one or more system processes, which manages retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 7001 might be coupled via the network 614 (e.g., the Internet), another application server 700N−1 might be coupled via a direct network link, and another application server 700N might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method comprising:
capturing a query that is directed to a multi-tenant database;
determining a plan by which the query will be applied to the database;
statically analyzing the plan for performance; and
applying a performance measure to the query.

2. The method of claim 1, further comprising generating a plurality of queries to exercise tables of the database and wherein capturing a query comprises capturing one of the plurality of generated queries.

3. The method of claim 1, wherein capturing a query comprises intercepting a query generated by a database user to be applied to the database.

4. The method of claim 1, wherein capturing a query comprises monitoring the performance of user queries to the database and identifying a user query with slow performance for capture.

5. The method of claim 1, wherein determining a plan comprises applying a plan explanation tool of the database.

6. The method of claim 5, wherein the plan explanation tool comprises an Oracle Explain Plan.

7. The method of claim 1, wherein statically analyzing the plan comprises checking the plan for specific operations.

8. The method of claim 7, wherein the specific operations include scanning a full table.

9. The method of claim 7, wherein the specific operations include merge join Cartesian operations.

10. The method of claim 7, wherein the specific operations include nested loop joins without an index containing the join key.

11. The method of claim 7, wherein the performance measure comprises preventing the query from being executed on the database.

12. The method of claim 7, wherein the performance measure is modifying the query to improve its performance when executed on the database.

13. The method of claim 7, wherein the performance measure is modifying the database to improve the performance of the query when executed on the database.

14. The method of claim 1, further comprising enhancing the query after capturing the query and before determining the plan.

15. The method of claim 1, wherein the database is a relational database and wherein enhancing the query includes translating the query into a structured query language.

16. A machine-readable medium carrying one or more sequences of instructions for validating queries in a multi-tenant database system, which instructions, when executed by one or more processors, cause the one or more processors to carry out the steps of:
capturing a query that is directed to a multi-tenant database;
determining a plan by which the query will be applied to the database;
statically analyzing the plan for performance; and
applying a performance measure to the query.

17. The machine-readable medium as recited in claim 16, wherein the instructions further cause the one or more processors to carry out the step of generating a plurality of queries to exercise tables of the database and wherein capturing a query comprises capturing one of the plurality of generated queries.

18. The machine-readable medium as recited in claim 16, wherein the instructions further cause the one or more processors to carry out the step of enhancing the query after capturing the query and before determining the plan.

19. The machine-readable medium as recited in claim 16, wherein the instructions for carrying out the step of statically analyzing the plan include instructions for carrying out the step of checking the plan for specific operations.

20. The machine-readable medium as recited in claim 19, wherein the instructions for checking the plan for specific operations include checking the plan for at least one of canning a full table, merge join Cartesian operations, and nested loop joins.

21. An apparatus for validating queries in a multi-tenant database, the apparatus comprising:
a processor; and
one or more stored sequences of instructions which, when executed by the processor, cause the processor to carry out the steps of:
capturing a query that is directed to a multi-tenant database;
determining a plan by which the query will be applied to the database;
statically analyzing the plan for performance; and
applying a performance measure to the query.

22. The apparatus as recited in claim 21, wherein the instructions for capturing a query cause the processor to carry out the steps of capturing one of the plurality of generated queries.

23. The apparatus as recited in claim 21, wherein the instructions for capturing a query cause the processor to carry out the steps of monitoring the performance of user queries to the database and identifying a user query with slow performance for capture.

24. The apparatus as recited in claim 23, wherein the performance measure comprises preventing the query from being executed on the database.

25. The apparatus as recited in claim 23, wherein the performance measure is modifying the query to improve its performance when executed on the database.
